(19) United States
(12) Patent Application Publication
(10) Pub. No.: US 2019/0129975 A1
(43) Pub. Date: May 2, 2019

(54) PERSISTENT CACHE LAYER LOCKING COOKIES

(71) Applicant: EMC IP Holding Company LLC, Hopkinton, MA (US)

(72) Inventors: Max Laier, Seattle, WA (US); Evgeny Popovich, Vancouver (CA)

(21) Appl. No.: 15/801,718

(22) Filed: Nov. 2, 2017

(51) Int. Cl. G06F 17/30; G06F 11/14

(52) U.S. Cl. CPC G06F 17/30171; G06F 17/30132; G06F 2201/84; G06F 11/1469; G06F 17/30088

(57) ABSTRACT

Implementations are provided herein for cluster wide unique and persistent locking cookie that can be generated and associated with a file. An operation, like in one example, a semantic operation, can be divided into multiple sub operations and each can be associated with the locking cookie that was placed on the file at the onset of the operation. While the locking cookie is in place on a file, any operation targeted to the file can have the cookie associated with the operation matched against the locking cookie, and only operations that have a matching cookie can proceed past the lock and have the operation performed by the file system. It can be appreciated the multiple sub operations can be performed in parallel if their operation cookie matches the locking cookie for the file. In one implementation, checkpoints can be established and progress towards checkpoints can be tracked to allow restarts of operations in the event of crashes or failures.

### CROSS REFERENCE TO RELATED APPLICATIONS

This application is related to co-pending U.S. patent application Ser. No. 15/581,337 (Attorney Docket No. EMC-16-1169) for PERSISTENT CACHE LAYER IN A DISTRIBUTED FILE SYSTEM; and to co-pending U.S. patent application Ser. No. 15/581,370 (Attorney Docket No. EMC-16-1170) for A PERSISTENT CACHE LAYER TO TIER DATA TO CLOUD STORAGE and to co-pending U.S. patent application Ser. No. ______ (Attorney Docket No. 109468) for BAKCUP WITHIN A FILE SYSTEM USING A PERSISTENT CACHE LAYER TO TIER DATA TO CLOUD STORAGE and filed concurrently herewith, which is incorporated herein by reference for all purposes.

### FIELD OF THE INVENTION

This invention relates generally to processing data, and more particularly to mechanisms for backing up file data stored in a file system using a persistent cache to tier data cloud storage.

### BACKGROUND OF THE INVENTION

Distributed file systems offer many compelling advantages in establishing high performance computing environments. One example is the ability to easily expand, even at large scale. Another example is the ability to store different types of data, accessible by different types of clients, using different protocols. In servicing different sets of clients, a distributed file system may offer data services such as compression, encryption, off-site tiering, etc.

In many file systems, each file is associated with a single data stream. For example, a unique inode of the file can store metadata related to the file and block locations within specific storage disks where the file data is stored. When a client or other file system process desire access to a file, the unique inode associated with the file can be determined, and then the inode can be read as part of the processing the file system operation.

When a file system operation targeted to an inode is being processed, the inode itself can be placed under lock conditions, impacting other file system processes that desire access to the same inode. In addition, the size of an inode can be limited, such that when metadata relating to the file the inode is associated with grows too large, it may need to be stored elsewhere. For example, if an inode is associated with a file that has been tiered to an external storage repository, metadata may be generated that describes the location with the external storage repository for different chunks of file data, account information needed to access the external repository, etc.

Using a persistent cache, at least two data streams can be associated with each file in a file system. The first, a cache overlay layer, can store additional state information on a per block basis that details whether each individual block of file data within the cache overlay layer is clean, dirty, or indicates that a write back to the storage layer is in progress. The second, a storage layer, can be a use case defined repository that can tier data to external repositories.

When performing tasks to modify data in the cache overlay layer and the storage layer, it can be necessary to lock an inode associated with each layer to prevent competing processes from both performing operations on the same target. For some operations, for example a semantic operation to “archive a file to cloud storage” or “recall a file from the cloud”, the semantic operation will be accomplished by performing multiple sub operations. However, using traditional file system locking would not guarantee that each sub operation of the semantic operation would be performed in sequence and/or in parallel without being interrupted by operations unrelated to the semantic operation. Therefore, there exists a need to provide operation locks that allow a set of related operations to be performed on a file while still locking out unrelated operations.

### SUMMARY

The following presents a simplified summary of the specification in order to provide a basic understanding of some aspects of the specification. This summary is not an extensive overview of the specification. It is intended to neither identify key or critical elements of the specification nor delineate the scope of any particular embodiments of the specification, or any scope of the claims. Its sole purpose is to present some concepts of the specification in a simplified form as a prelude to the more detailed description that is presented in this disclosure.

In accordance with an aspect, at least two data streams for each file can maintained, wherein a first data stream is associated with a cache overlay layer and a second data stream is associated with a storage. A logical inode tree that at least maps each file in the file system to a cache overlay layer inode and a storage layer inode can be maintained, wherein the cache overlay layer inode contains metadata identifying a chunk state for each chunk of file data. An operation lock can be generated on a file, wherein the operation lock generates and associated a locking cookie with the file. An operation targeted to the file can be received, wherein the operation is associated with an operation cookie. In response to the operation cookie not matching the locking cookie, blocking the operation. In response to the operation cookie matching the locking cookie, performing the operation.

In accordance with another aspect, a second operation targeted to the file can be received, wherein the second operation is associated with a second operation cookie. In response to the second operation cookie not matching the locking cookie, blocking the second operation. In response to the second operation cookie matching the locking cookie, performing the second operation. The operation and the second operation can be performed in parallel.

In accordance with another aspect, a semantic operation targeted to a file can be a received. The semantic operation can be divided into a set of operations. Each operation in the set of operations can be associated with an operation cookie. A set of checkpoints can be established with the semantic operation. Progress of the set of checkpoints can be tracked based on performing the set of operations. In response to an interruption of the set of operations, operations in the set of operations can be recovered based on the tracking progress of the set of checkpoints.

The following description and the drawings set forth certain illustrative aspects of the specification. These aspects are indicative, however, of but a few of the various ways in which the principles of the specification may be employed. Other advantages and novel features of the specification will become apparent from the detailed description of the specification when considered in conjunction with the drawings.

### BRIEF DESCRIPTION OF THE DRAWINGS

FIG. 1 illustrates an example illustration of data flow between a cache overlay layer and a storage layer in accordance with implementations of this disclosure;

FIG. 2 illustrates three example files having separate data streams for a cache overlay layer and a storage layer in accordance with implementations of this disclosure;

FIG. 3 illustrates an example flow diagram method for performing a backup in a file system using a persistent cache layer to tier data to cloud storage in accordance with implementations of this disclosure;

FIG. 4 illustrates an example flow diagram method for using a locking cookie in a file system using a persistent cache layer in accordance with implementations of this disclosure;

FIG. 5 illustrates an example flow diagram method for using a locking cookie in a file system using a persistent cache layer to perform multiple operations in parallel in accordance with implementations of this disclosure;

FIG. 6 illustrates an example flow diagram method for using a locking cookie in a file system using a persistent cache layer to perform a semantic operation in accordance with implementations of this disclosure;

FIG. 7 illustrates an example flow diagram method for using a locking cookie in a file system using a persistent cache layer to perform a semantic operation while tracking progress of a set of operations in accordance with implementations of this disclosure;

FIG. 8 illustrates an example block diagram of a cluster of nodes in accordance with implementations of this disclosure; and

FIG. 9 illustrates an example block diagram of a node in accordance with implementations of this disclosure.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of this innovation. It may be evident, however, that the innovation can be practiced without these specific details. In other instances, well-known structures and devices are shown in block diagram form in order to facilitate describing the innovation.

As used herein, the term “node” refers to a physical computing device, including, but not limited to, network devices, servers, processors, cloud architectures, or the like. In at least one of the various embodiments, nodes may be arranged in a cluster interconnected by a high-bandwidth, low latency network backplane. In at least one of the various embodiments, non-resident clients may communicate to the nodes in a cluster through high-latency, relatively low-bandwidth front side network connections, such as Ethernet, or the like.

The term “cluster of nodes” refers to one or more nodes that operate together to form a distributed file system. In one example, a cluster of nodes forms a unified namespace for a distributed file system. Nodes within a cluster may communicate information about nodes within the cluster to other nodes in the cluster. Nodes among the cluster of nodes function using the same logical inode number “LIN” mappings that describe the physical location of the data stored within the file system. For example, there can be a LIN to inode addresses mapping where inode addresses describe the physical location of the metadata stored for a file within the file system, and a data tree that maps logical block numbers to the physical location of the data stored. In one implementation, nodes among the cluster of nodes run a common operating system kernel. Clients can connect to any one node among the cluster of nodes and access data stored within the cluster. For example, if a client is connected to a node, and that client requests data that is not stored locally within the node, the node can then load the requested data from other nodes of the cluster in order to fulfill the request of the client. Data protection plans can exist that stores copies or instances of file system data striped across multiple drives in a single node and/or multiple nodes among the cluster of nodes, thereby preventing failures of a node or a storage drive from disrupting access to data by the clients. Metadata, such as inodes, for an entire distributed file system can be mirrored and/or synched across all nodes of the cluster of nodes.

The term “inode” as used herein refers to in-memory representation of on-disk data structures that may store information, or meta-data, about files and directories, such as file size, file ownership, access mode (read, write, execute permissions), time and date of creation and modification, file types, data protection process information such as encryption and/or compression information, snapshot information, hash values associated with location of the file, mappings to cloud data objects, pointers to a cloud metadata objects, etc. In one implementation, inodes may be in a known location in a file system, for example, residing in cache memory for fast and/or efficient access by the file system. In accordance with implementations disclosed herein, separate inodes can exist for the same file, one inode associated with the cache overlay layer and a second inode associated with the storage layer.

A “LIN Tree” is an inode index that stores references to at least a cache overlay inode and a storage overlay inode for each file in the file system. The LIN tree maps a LIN, a unique identifier for a file, to a set of inodes. Before or in conjunction with performing a file system operation on a file or directory, a system call may access the contents of the LIN Tree and find the cache overlay inode and/or the storage overlay inode associated with the file as a part of processing the file system operation.

In some implementations, a data structure explicitly named “inode” or LIN may be absent, but file systems may have data structures that store data similar to LINs and may provide capabilities similar to LINs as described herein. It can be appreciated that the concepts and implementations as provided herein are functional using data structures not termed LINs or inodes but that offer the same functionality to the file system.

A “cache overlay layer” is a logical layer of a file system that is the target for most requests from file system clients. While named a “cache overlay layer”, the layer itself is not required to be physically stored in a cache memory or memory cache that typically denote small sections of physical disks with fast access or other special characterizes within a data processing system. It can be appreciated that the cache overlay layer can be stored on any physical media of the local storage system that is accessible by the cluster of nodes, and can be replicated and/or striped across different local storage disks for data redundancy, backup, or other performance purposes.

A “storage overlay layer” is a logical layer of a file system that is a use-case defined repository for each file. Each file can be associated with a storage layer inode that maps the file data to a storage layer protection group. For example, for one file, the storage layer can treat the storage layer inode, and associated file data, like a normal file system file where unmodified raw data is stored on local physical disks mapped and managed by the file system and referenced within the storage layer inode. In another example, the storage layer associated with the storage layer inode can facilitate tiering of file data to an external repository. The storage layer can contain tiering account data, or other metadata necessary to transform or retrieve the raw data can be stored as metadata within the storage layer protection groups. File system administrators can associate a storage layer inode or a group of storage layer inodes with protection groups that have the appropriate data augmentations for each file.

### Using a Persistent Cache Layer within a File System

Implementations are provided herein for having at least two data streams associated with each file in a file system. The first, a cache overlay layer, can store additional state information on a per block basis that details whether each individual block of file data within the cache overlay layer is clean, dirty, or indicates that a write back to the storage layer is in progress. The second, a storage layer, can be a use case defined repository including to tier data to external repositories or store unmodified raw data in local storage.

In one implementation most client requests when interacting with files can be targeted to the cache overlay layer. The cache overlay inode associated with the file can have per-block state information for each block of file data that states whether the block is clean (the block matches the raw data in the storage layer); dirty (the block does not match the raw data in the storage layer); write-back-in-progress (for example, previously labeled dirty data is in the process of being copied into the storage layer); or empty (It is not currently populated with data). It can be appreciated that data can be filled from the storage layer into the cache overlay layer when necessary to process read operations or write operations targeted to the cache overlay layer. The kernel can use metadata associated with the storage layer inode of the file to find the storage layer data of the file, process the data (e.g., retrieve from an external location) and fill the data into the cache overlay layer. It can be appreciated that file system operations that work to tier data stored within the storage layer can be processed asynchronously from processing client requests to the cache overlay layer.

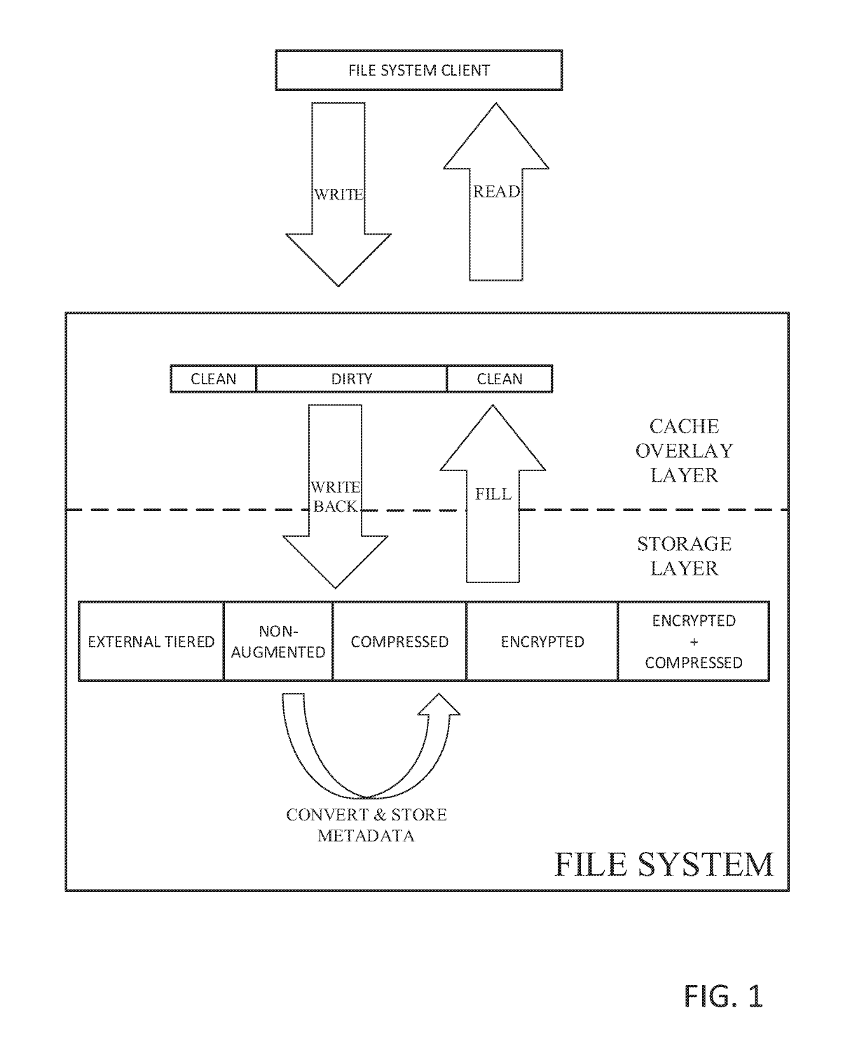

FIG. 1 illustrates an example illustration of data flow between a cache overlay layer and a storage layer in accordance with implementations of this disclosure. The file system client can perform operations (e.g., reads and writes as depicted in FIG. 1) that are targeted to a file. Using the LIN tree, a process can find the cache overlay inode and the storage layer inode associated with the file. The operations can proceed using the cache overlay inode. As stated above, the cache overlay inode can contain per-block state information associated with the data of the file. As shown on FIG. 1, the file data in the cache overlay layer shows some blocks of the file marked as clean, and some marked as dirty.

It can be appreciated that depending on the operation being requested by the file system client, the cache overlay layer may need to fill data from the storage layer into the cache overlay layer to process the operation. For example, if the file system client is requesting to read data that is currently empty in the cache overlay layer, a process can be started to fill data from the storage overlay layer into the cache overlay layer for the requested blocks. Using the storage layer inode that is associated with the file inode, the kernel can identify if any augmentation process has been applied to data that is referenced by the storage layer inode, and then retrieve and/or transform the data as necessary before it is filled into the cache overlay layer.

In one example, non-augmented data can be stored in the storage layer of the file system. For example, the storage layer inode can contain the block locations within local storage where the non-augmented data is stored. In another example, the cache overlay layer can be targeted to faster access memory while the storage layer can be targeted to local storage that has slower to access storage drives.

In another example, raw file data can be compressed within the storage layer. The storage layer inode can be associated with a protection group that provides for compression of file data. Metadata stored within the storage layer inode can contain references to the compression algorithm used to compress and/or decompress the file data. When a file system operation operates to fill compressed data from the storage layer into the cache overlay layer, the metadata within the storage layer inode can be used in uncompressing the data from the storage layer before storing it in the cache overlay layer for access by file system clients. When a file system operation operates to write data back into the storage layer, the storage layer inode can be used to compress the data from the cache overlay layer before storing it within the storage overlay layer.

In another example, raw file data can be encrypted within the storage layer. The storage layer inode can be associated with a protection group that provides for encryption of file data. Metadata stored within the storage layer inode can contain references to the encryption algorithm used to encrypt the data and/or decrypt the data. For example, a key-value pair associated with an encryption algorithm can be stored within the storage layer inode. When a file system operation operates to fill encrypted data from the storage layer into the cache overlay layer, the metadata within the storage layer inode can be used to decrypt the data from the storage layer before storing it in the cache overlay layer for access by file system clients. When a file system operation operates to write data back into the storage layer, the storage layer inode can be used to encrypt the data from the cache overlay layer before storing it within the storage overlay layer.

In another example, raw file data can be tiered to external storage. The storage layer inode can be associated with a protection group that provides for tiering of file data. Metadata stored within the storage layer inode can contain references to an external storage location, an external storage account, checksum information, cloud object mapping information, cloud metadata objects (“CMOs”), cloud data objects (“CDOs”), etc. When a file system operation operates to fill data stored in an external storage location form the storage layer into the cache overlay layer, the metadata within the storage layer inode can be used to retrieve the data from the external storage location and then storing the retrieved data in the cache overlay layer for access by file system clients. When a file system operation operates to write data back into the storage layer, the storage layer inode can be used to store necessary metadata generated from storing a new data object in an external storage location, and then tier the data from the cache storage overlay layer to the external storage location in conjunction with storing the metadata within the storage overlay layer inode.

In another example, a file can be at least two of compressed, encrypted, or tiered to cloud storage where any necessary metadata required to accomplish the combination, as referenced above individually, is stored within the storage overlay inode.

It can be appreciated that in some implementations, the kernel can understand what parts of the storage layer are in what state, based at least in part on protection group information and storage layer inode information, and can handle data transformations without having to fall back to user-space logic.

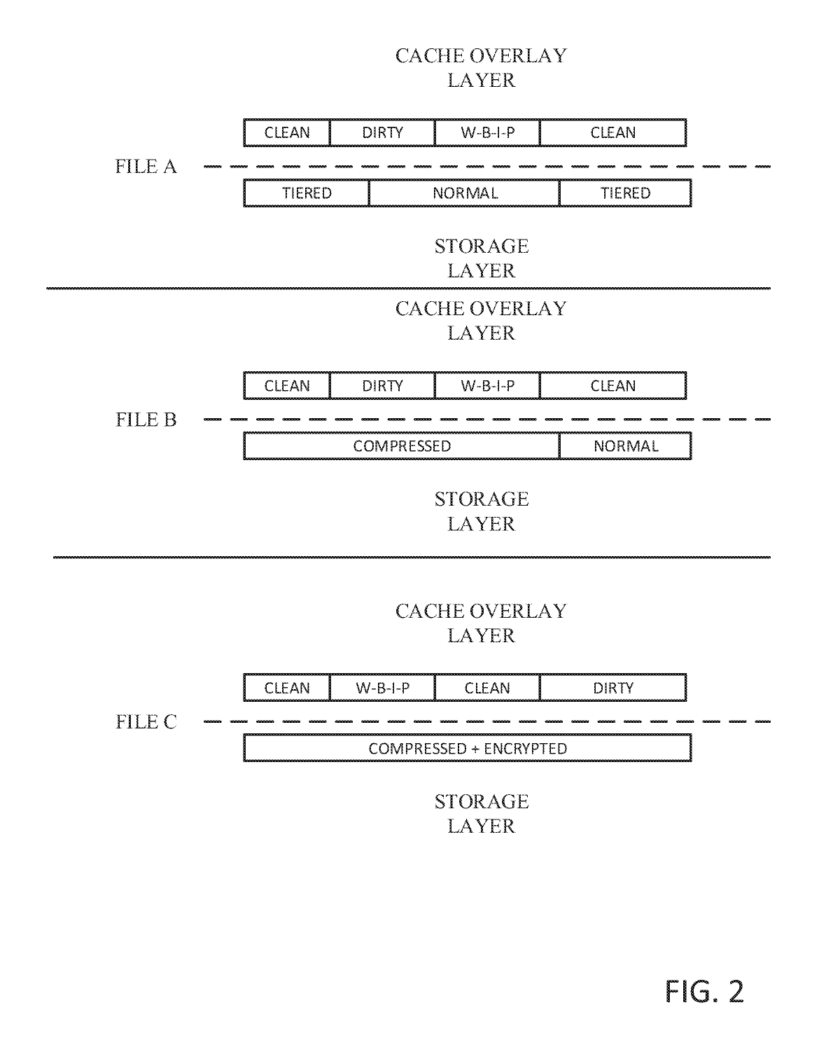

FIG. 2 illustrates three example files having separate data streams for a cache overlay layer and a storage layer in accordance with implementations of this disclosure.

File A is associated with a unique file LIN that references both a unique cache overlay layer inode and a unique storage layer inode. The cache overlay inode contains per block state information that describes four sections of block file data: A first clean section, a dirty section, a section marked write-back-in-progress, and a second clean section. The storage overlay layer inode references three sections of file data, a first and third section whereby the file data has been tiered to an external storage location, and a second section that exists as normal storage with the storage layer. It can be appreciated that as operations to the storage layer can be processed asynchronously from the cache overlay layer, the storage layer data, as depicted, could be in the middle of a process that is tiering all file data to cloud storage, where the second section has yet to be tiered. It can also be appreciated that metadata stored within the storage layer inode of File A can describe any necessary external tier information that can locate the data in the external storage location such as a CDO or CMO information as referenced in the incorporated references.

File B is also associated with its own unique LIN that references both a unique cache overlay layer inode and a unique storage layer inode. The cache overlay inode contains per block state information that describes four sections of block file data: A first clean section, a dirty section, a section marked write-back-in-progress, and a second clean section. The storage layer inode references two sections of file data, a first section that is compressed, and a second section that is normal non-augmented file data.

File C is also associated with its own unique LIN that references both a unique cache overlay layer inode and a unique storage layer inode. The cache overlay inode contains per block state information that describes four sections of block file data: A first clean section, a section marked write-back-in-progress, a second clean section and a second dirty section. The storage layer inode references a single section of file data that is both compressed and encrypted.

### Persistent Cache Layer Locking Cookies

When performing tasks to modify data in the cache overlay layer and the storage layer, it can be necessary to lock an inode associated with each layer to prevent competing processes from both performing operations on the same target. For some operations, for example a semantic operation to “archive a file to cloud storage” or “recall a file from the cloud”, the semantic operation will be accomplished by performing multiple sub operations. However, using traditional file system locking would not guarantee that each sub operation of the semantic operation would be performed in sequence and/or in parallel without being interrupted by operation unrelated to the semantic operation.

Implementations are provided herein for cluster wide unique and persistent locking cookie that can be generated and associated with a file. An operation, like in one example, a semantic operation, can be divided into multiple sub operations and each can be associated with the locking cookie that was placed on the file at the onset of the operation. While the locking cookie is in place on a file, any operation targeted to the file can have the cookie associated with the operation matched against the locking cookie, and only operations that have a matching cookie can proceed past the lock and have the operation performed by the file system. It can be appreciated that multiple sub operations can be performed in parallel if their operation cookie matches the locking cookie for the file. In one implementation, checkpoints can be established and progress towards checkpoints can be tracked to allow restarts of operations in the event of crashes or failures.

It can be appreciated that without the method that provides for multiple sub operations to bypass the locking cookie, each sub operation would have to be performed serially with individual locking, increasing the computational costs associated with generating, managing, and deleting large sets of individual locks. It can also be appreciated that serially locking operation may lose any advantages of parallel performance. It can also be appreciated that serially locking operations may allow for an operation that is unrelated to the otherwise related sub-operations to interrupt and potentially impact the set of related sub-operations.

In one implementation, semantic operations targeted to tiering files to cloud storage within a file system using a persistent cache layer are targeted. For example, semantic operations can include archive a file, recall a file, write-back operations, cache fill operations, and others.

In one implementation, the cluster wide locking cookie is a 64 bit value. In one implementation, the locking cookie's uniqueness can be guaranteed by its cluster-wide atomic allocation.

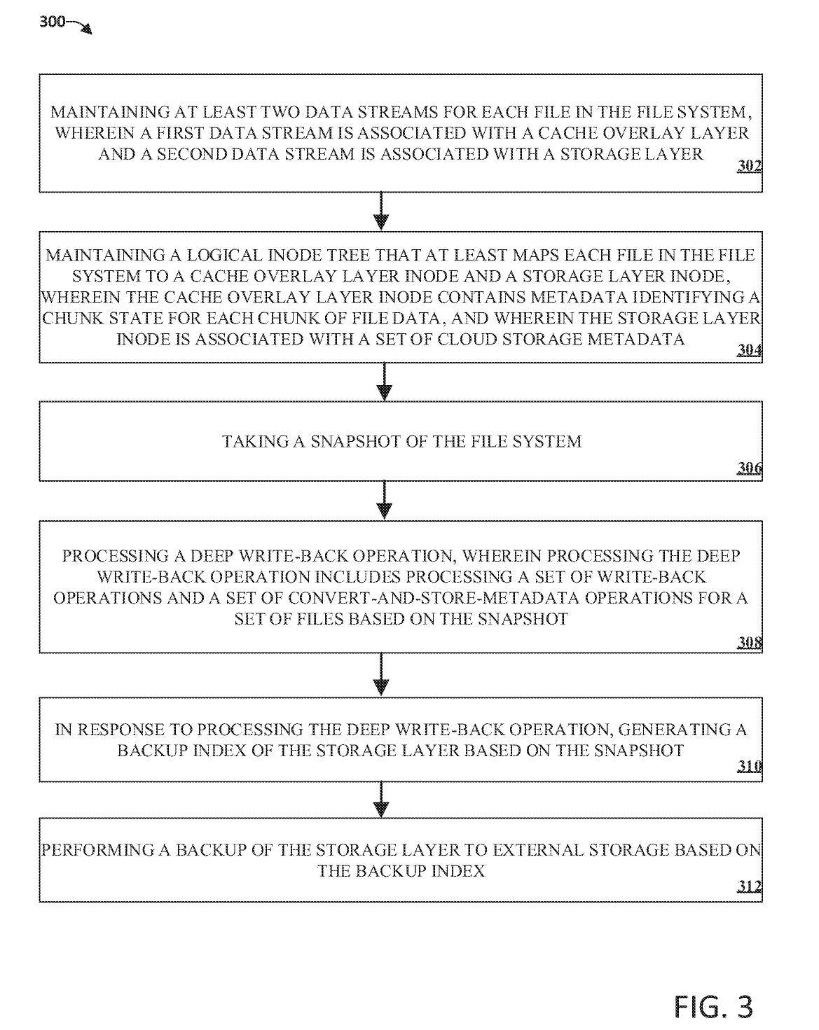

FIGS. 3-7 illustrate methods and/or flow diagrams in accordance with this disclosure. For simplicity of explanation, the methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

Moreover, various acts have been described in detail above in connection with respective system diagrams. It is to be appreciated that the detailed description of such acts in the prior figures can be and are intended to be implementable in accordance with one or more of the following methods.

Referring now to FIG. 3, there is illustrated an example flow diagram method for performing a backup in a file system using a persistent cache layer to tier data to cloud storage in accordance with implementations of this disclosure. At 302, at least two data streams for each file can maintained, wherein a first data stream is associated with a cache overlay layer and a second data stream is associated with a storage. At 304, a logical inode tree that at least maps each file in the file system to a cache overlay layer inode and a storage layer inode can be maintained, wherein the cache overlay layer inode contains metadata identifying a chunk state for each chunk of file data, and wherein the storage layer inode is associated with a set of cloud storage metadata.

At 306, a snapshot can be taken of the file system. In one implementation, the snapshot is a subset of files of the file system. In one implementation, the snapshot is generated from at least one of a user generated backup request or an automated backup request.

At 308, a deep write-back operation can be processed, wherein processing the deep write-back operation includes processing a set of write-back operations and a set of convert-and-store-metadata operations for a set of files based on the snapshot. For example, any file that is part of the snapshot that has cache overlay chunks that are marked dirty can be written-back to the storage layer, by being converted to metadata references, and having the file data tiered to the cloud. In one implementation, processing the deep write-back operation locks a set of files associated with the snapshot from modifications.

At 310, in response to processing the deep-write back operation, a backup index of the storage layer can be generated based on the snapshot. For example, and NDMP backup index can be generated.

At 312, a backup of the storage to external storage can be performed based on the backup index. For example, an NDMP backup process can use the index to dump indexed data from the storage layer to an external tape drive or other external storage media. In one implementation, a size of the backup data in the backup index remains unchanged when performing the backup of the storage layer to external storage. It can be appreciated that the size of the backup index remains unchanged even as data in the cache overlay is modified following the deep write-back process but prior to the completion of the backup.

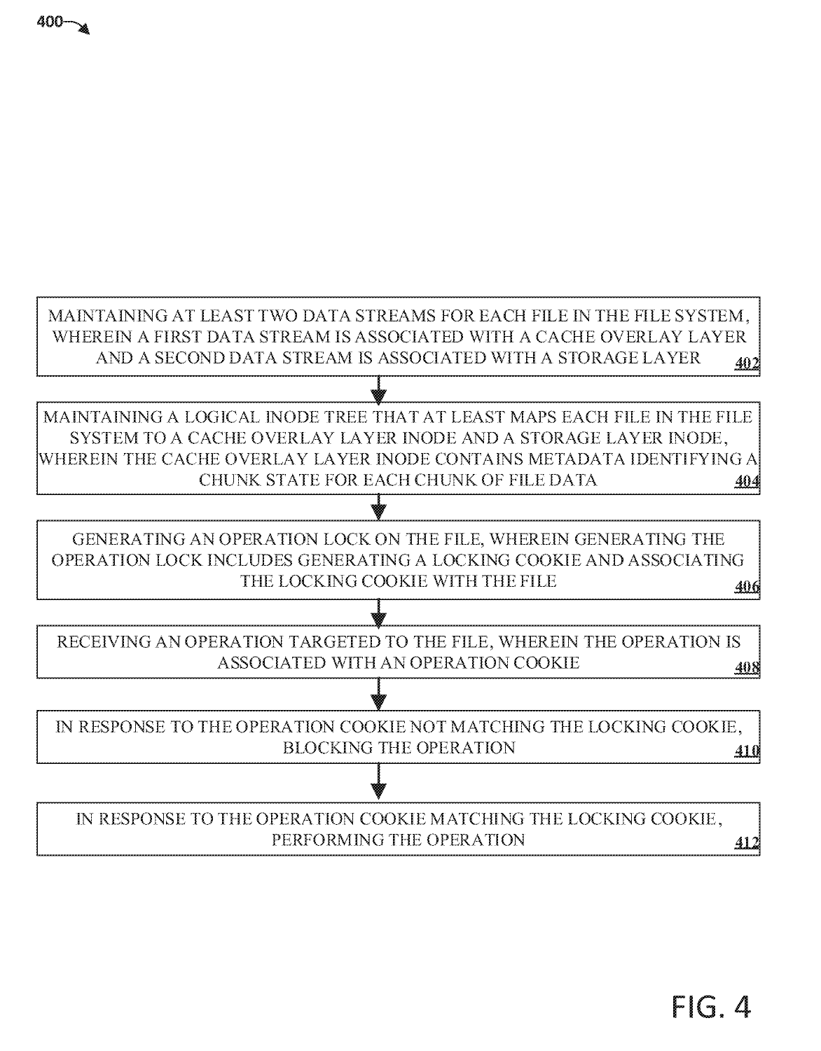

Referring now to FIG. 4, there is illustrated an example flow diagram method for using a locking cookie in a file system using a persistent cache layer in accordance with implementations of this disclosure. At 402, at least two data streams for each file can maintained, wherein a first data stream is associated with a cache overlay layer and a second data stream is associated with a storage. At 404, a logical inode tree that at least maps each file in the file system to a cache overlay layer inode and a storage layer inode can be maintained, wherein the cache overlay layer inode contains metadata identifying a chunk state for each chunk of file data.

At 406, an operation lock can be generated on a file, wherein generating the operation lock includes generating and associating a locking cookie with the file. In one implementation, the locking cookie can be a 64 bit value.

At 408, an operation targeted to the file can be received, wherein the operation is associated with an operation cookie.

At 410, in response to the operation cookie not matching the locking cookie, blocking the operation.

At 412, in response to the operation cookie matching the locking cookie, performing the operation.

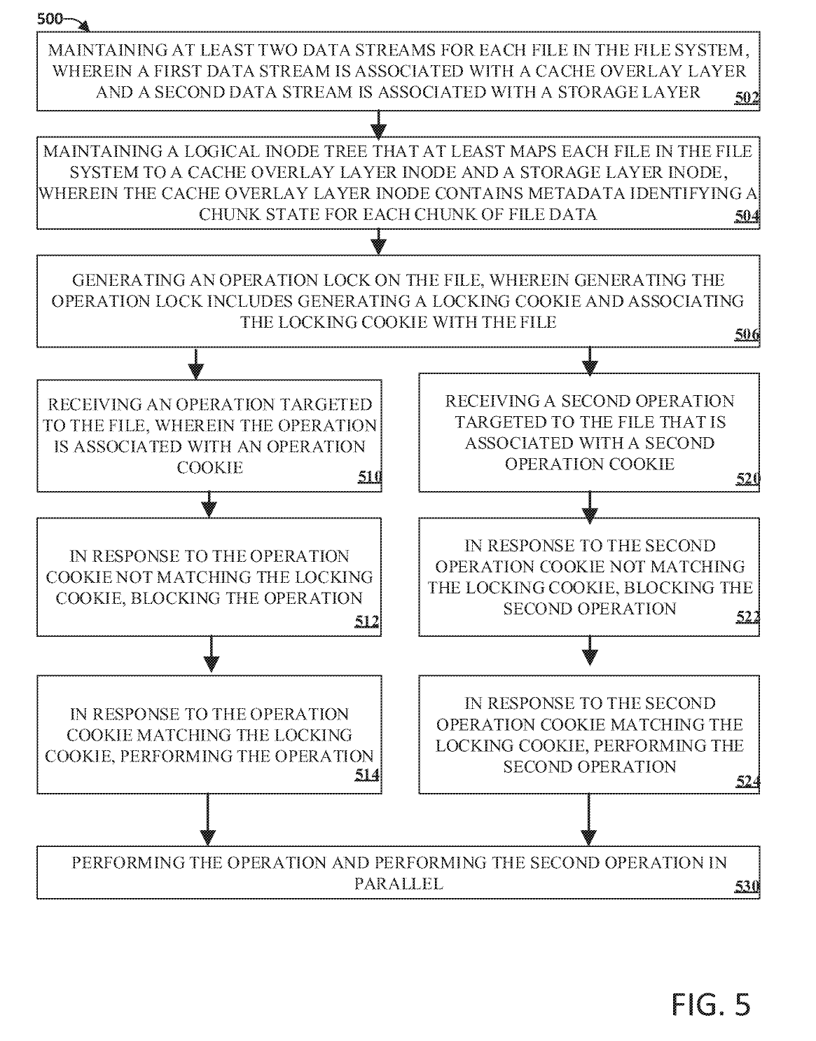

Referring now to FIG. 5, there is illustrated an example flow diagram method for using a locking cookie in a file system using a persistent cache layer to perform multiple operations in parallel in accordance with implementations of this disclosure. At 502, at least two data streams for each file can maintained, wherein a first data stream is associated with a cache overlay layer and a second data stream is associated with a storage. At 504, a logical inode tree that at least maps each file in the file system to a cache overlay layer inode and a storage layer inode can be maintained, wherein the cache overlay layer inode contains metadata identifying a chunk state for each chunk of file data. At 506, an operation lock can be generated on a file, wherein generating the operation lock includes generating and associating a locking cookie with the file.

At 510, an operation targeted to the file can be received, wherein the operation is associated with an operation cookie. At 512, in response to the operation cookie not matching the locking cookie, blocking the operation. At 514, in response to the operation cookie matching the locking cookie, performing the operation.

At 520, a second operation targeted to the file can be received, wherein the second operation is associated with a second operation cookie. At 522, in response to the second operation cookie not matching the locking cookie, blocking the second operation. At 524, in response to the second operation cookie matching the locking cookie, performing the second operation.

At 530, the operation and the second operation can be performed in parallel.

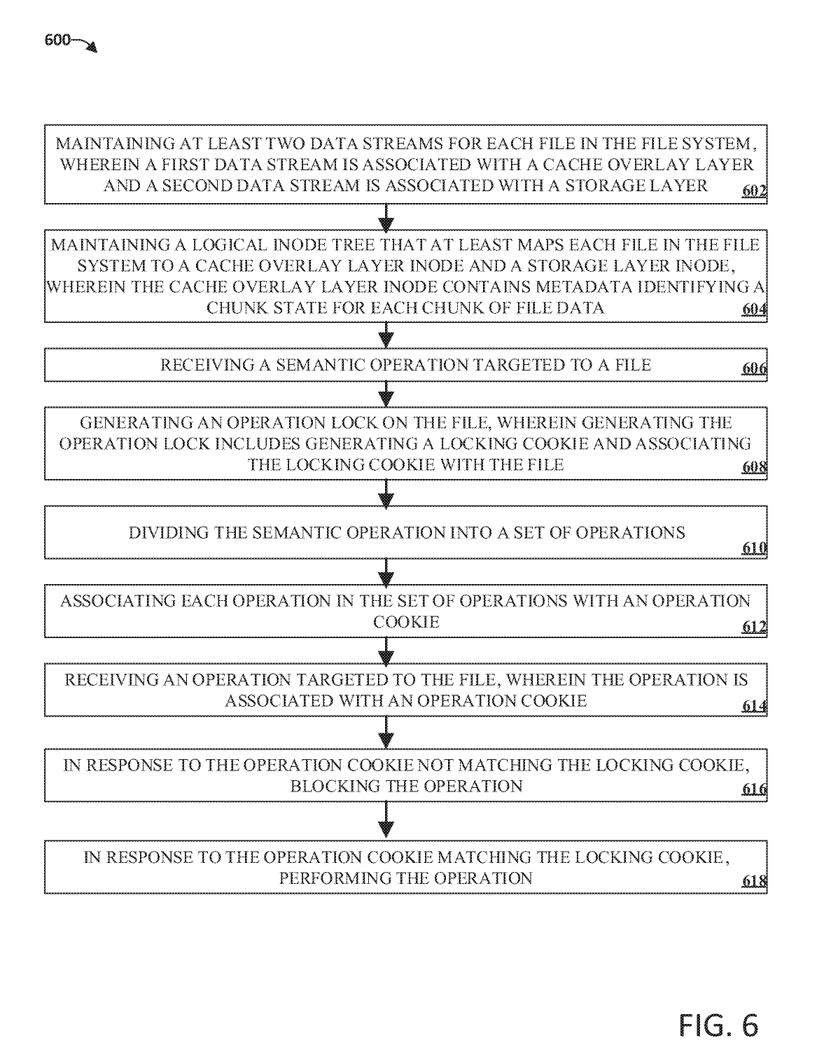

Referring now to FIG. 6, there is illustrated an example flow diagram method for using a locking cookie in a file system using a persistent cache layer to perform a semantic operation in accordance with implementations of this disclosure. At 602, at least two data streams for each file can maintained, wherein a first data stream is associated with a cache overlay layer and a second data stream is associated with a storage. At 604, a logical inode tree that at least maps each file in the file system to a cache overlay layer inode and a storage layer inode can be maintained, wherein the cache overlay layer inode contains metadata identifying a chunk state for each chunk of file data.

At 606, a semantic operation targeted to a file can be a received.

At 608, an operation lock can be generated on a file, wherein generating the operation lock includes generating and associating a locking cookie with the file.

At 610, the semantic operation can be divided into a set of operations.

At 612, each operation in the set of operations can be associated with an operation cookie.

At 614, an operation targeted to the file can be received, wherein the operation is associated with an operation cookie.

At 616, in response to the operation cookie not matching the locking cookie, blocking the operation.

At 618, in response to the operation cookie matching the locking cookie, performing the operation. It can be appreciated that sub operations associated with the semantic operation can be performed in parallel as illustrated in FIG. 5.

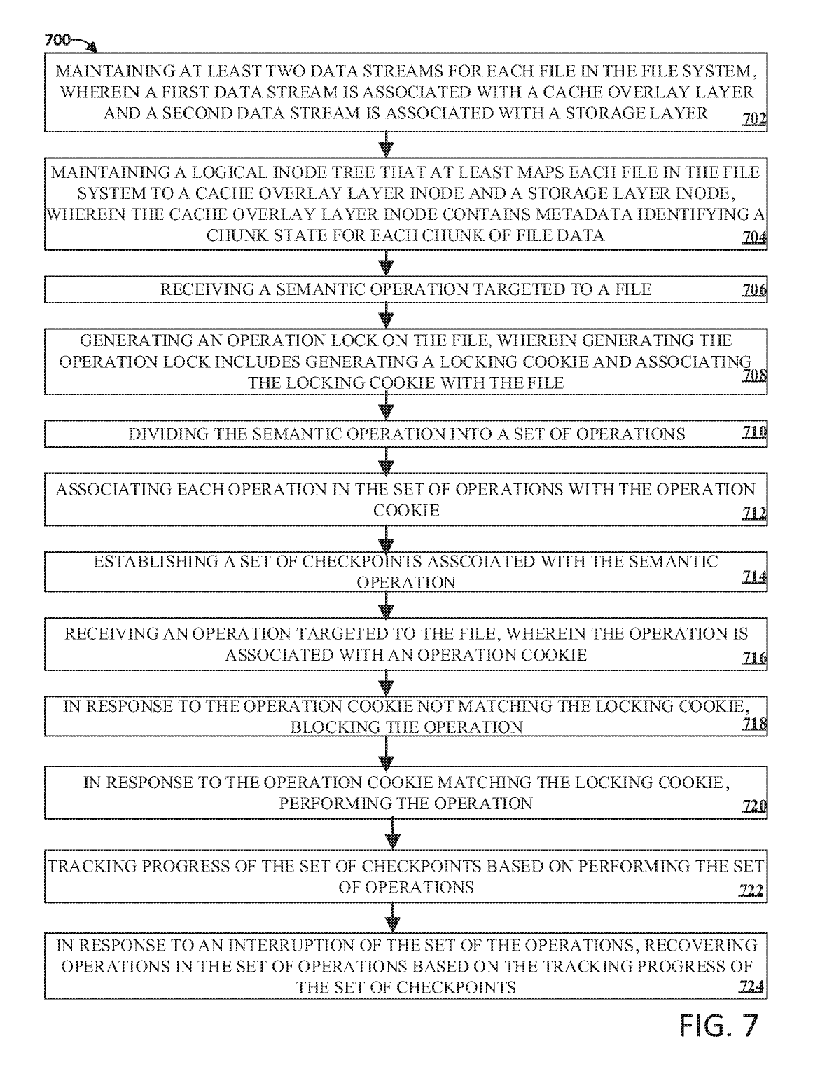

Referring now to FIG. 7, there is illustrated an example flow diagram method for using a locking cookie in a file system using a persistent cache layer to perform a semantic operation while tracking progress of a set of operations in accordance with implementations of this disclosure. At 702, at least two data streams for each file can maintained, wherein a first data stream is associated with a cache overlay layer and a second data stream is associated with a storage. At 704, a logical inode tree that at least maps each file in the file system to a cache overlay layer inode and a storage layer inode can be maintained, wherein the cache overlay layer inode contains metadata identifying a chunk state for each chunk of file data.

At 706, a semantic operation targeted to a file can be a received.

At 708, an operation lock can be generated on a file, wherein generating the operation lock includes generating and associating a locking cookie with the file.

At 710, the semantic operation can be divided into a set of operations.

At 712, each operation in the set of operations can be associated with an operation cookie.

At 714, a set of checkpoints can be established with the semantic operation.

At 716, an operation targeted to the file can be received, wherein the operation is associated with an operation cookie. At 718, in response to the operation cookie not matching the locking cookie, blocking the operation. At 720, in response to the operation cookie matching the locking cookie, performing the operation.

At 722, progress of the set of checkpoints can be tracked based on performing the set of operations.

At 724, in response to an interruption of the set of operations, operations in the set of operations can be recovered based on the tracking progress of the set of checkpoints.

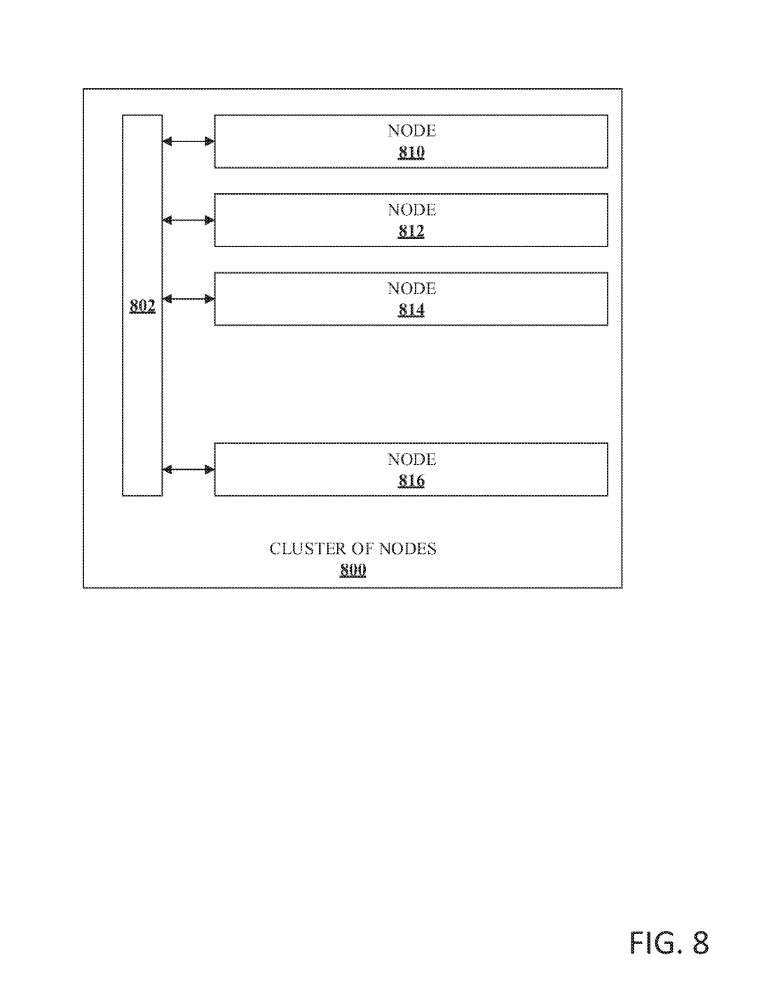

FIG. 8 illustrates an example block diagram of a cluster of nodes in accordance with implementations of this disclosure. However, the components shown are sufficient to disclose an illustrative implementation. Generally, a node is a computing device with a modular design optimized to minimize the use of physical space and energy. A node can include processors, power blocks, cooling apparatus, network interfaces, input/output interfaces, etc. Although not shown, a cluster of nodes typically includes several computers that merely require a network connection and a power cord connection to operate. Each node computer often includes redundant components for power and interfaces. The cluster of nodes 800 as depicted shows Nodes 810, 812, 814 and 816 operating in a cluster; however, it can be appreciated that more or less nodes can make up a cluster. It can be further appreciated that nodes among the cluster of nodes do not have to be in a same enclosure as shown for ease of explanation in FIG. 8, and can be geographically disparate. Backplane 802 can be any type of commercially available networking infrastructure that allows nodes among the cluster of nodes to communicate amongst each other in as close to real time as the networking infrastructure allows. It can be appreciated that the backplane 802 can also have a separate power supply, logic, I/O, etc. as necessary to support communication amongst nodes of the cluster of nodes.

It can be appreciated that the Cluster of Nodes 800 can be in communication with a second Cluster of Nodes and work in conjunction to provide a distributed file system. Nodes can refer to a physical enclosure with a varying amount of CPU cores, random access memory, flash drive storage, magnetic drive storage, etc. For example, a single Node could contain, in one example, 36 disk drive bays with attached disk storage in each bay. It can be appreciated that nodes within the cluster of nodes can have varying configurations and need not be uniform.

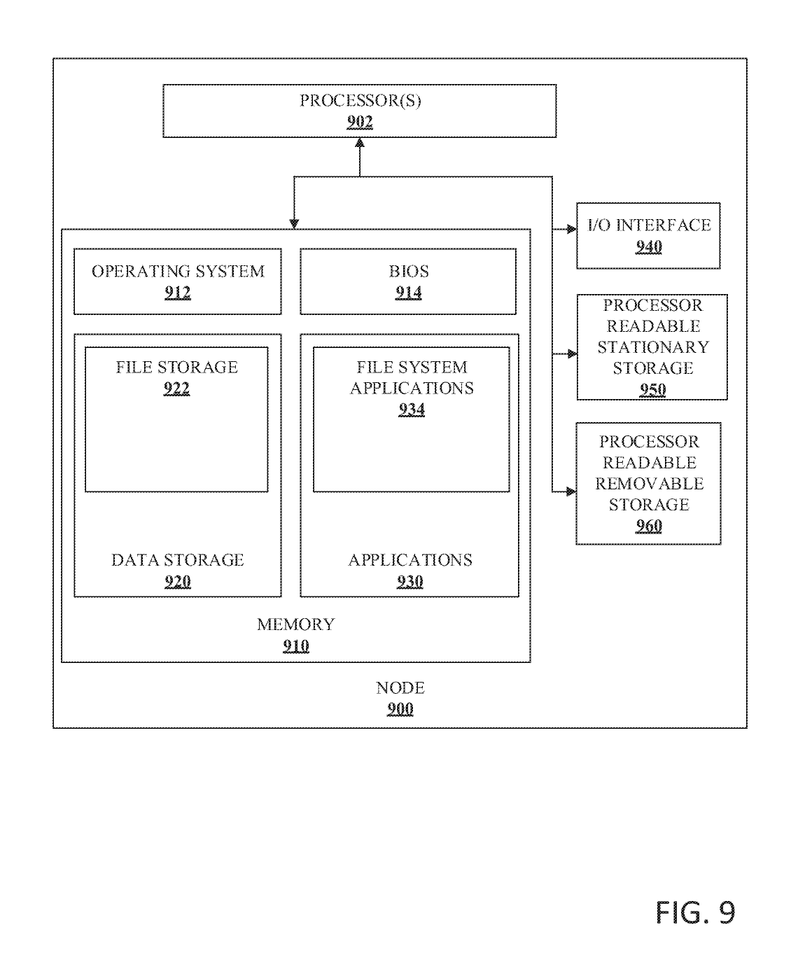

FIG. 9 illustrates an example block diagram of a node 900 in accordance with implementations of this disclosure.

Node 900 includes one or more processor 902 which communicates with memory 910 via a bus. Node 900 also includes input/output interface 940, processor-readable stationary storage device(s) 950, and processor-readable removable storage device(s) 960. Input/output interface 940 can enable node 900 to communicate with other nodes, mobile devices, network devices, and the like. Processor-readable stationary storage device 950 may include one or more devices such as an electromagnetic storage device (hard disk), solid state hard disk (SSD), hybrid of both an SSD and a hard disk, and the like. In some configurations, a node may include many storage devices. Also, processor-readable removable storage device 960 enables processor 902 to read non-transitive storage media for storing and accessing processor-readable instructions, modules, data structures, and other forms of data. The non-transitive storage media may include Flash drives, tape media, floppy media, disc media, and the like.

Memory 910 may include Random Access Memory (RAM), Read-Only Memory (ROM), hybrid of RAM and ROM, and the like. As shown, memory 910 includes operating system 912 and basic input/output system (BIOS) 914 for enabling the operation of node 900. In various embodiments, a general-purpose operating system may be employed such as a version of UNIX™ LINUX™, a specialized server operating system such as Microsoft's Windows Server™ and Apple Computer's IoS Server™, or the like.

Applications 930 may include processor executable instructions which, when executed by node 900, transmit, receive, and/or otherwise process messages, audio, video, and enable communication with other networked computing devices. Examples of application programs include database servers, file servers, calendars, transcoders, and so forth. File System Applications 934 may include, for example, metadata applications, and other file system applications according to implementations of this disclosure.

Human interface components (not pictured), may be remotely associated with node 900, which can enable remote input to and/or output from node 900. For example, information to a display or from a keyboard can be routed through the input/output interface 940 to appropriate peripheral human interface components that are remotely located. Examples of peripheral human interface components include, but are not limited to, an audio interface, a display, keypad, pointing device, touch interface, and the like.

Data storage 920 may reside within memory 910 as well, storing file storage 922 data such as metadata or file data. It can be appreciated that file data and/or metadata can relate to file storage within processor readable stationary storage 950 and/or processor readable removable storage 960 and/or externally tiered storage locations (not pictured) that are accessible using I/O interface 940. For example, file data may be cached in memory 910 for faster or more efficient frequent access versus being stored within processor readable stationary storage 950. In addition, Data storage 920 can also host policy data 924 such as sets of policies applicable to different access zone in accordance with implementations of this disclosure. Index and table data can be stored as files in file storage 922.

The illustrated aspects of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders that are not all of which may be explicitly illustrated herein.

What has been described above includes examples of the implementations of the present disclosure. It is, of course, not possible to describe every conceivable combination of components or methods for purposes of describing the claimed subject matter, but many further combinations and permutations of the subject innovation are possible. Accordingly, the claimed subject matter is intended to embrace all such alterations, modifications, and variations that fall within the spirit and scope of the appended claims. Moreover, the above description of illustrated implementations of this disclosure, including what is described in the Abstract, is not intended to be exhaustive or to limit the disclosed implementations to the precise forms disclosed. While specific implementations and examples are described herein for illustrative purposes, various modifications are possible that are considered within the scope of such implementations and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable storage medium having computer-executable instructions for performing the acts and/or events of the various methods of the claimed subject matter.

What is claimed is:

1. A method comprising:
maintaining at least two data streams for each file in a file system, wherein a first data stream is associated with a cache overlay layer and a second data stream is associated with a storage layer;
maintaining a logical inode tree that at least maps each file in the file system to a cache overlay layer inode and a storage layer inode, wherein the cache overlay layer inode contains metadata identifying a chunk state for each chunk of file data;
generating an operation lock on a file, wherein generating the operation lock includes generating a locking cookie and associating the locking cookie with the file;
receiving an operation targeted to the file, wherein the operation is associated with an operation cookie;
in response to the operation cookie not matching the locking cookie, blocking the operation; and
in response to the operation cookie matching the locking cookie, performing the operation;

2. The method of claim 1, further comprising:
receiving a second operation targeted to the file that is associated with a second operation cookie;
in response to the second operation cookie not matching the locking cookie, blocking the second operation;
in response to the second operation cookie matching the locking cookie, performing the second operation.

3. The method of claim 2, wherein performing the operation and performing the second operation in parallel.

4. The method of claim 1, further comprising:
receiving a semantic operation targeted to the file;
dividing the semantic operation into a set of operations; and
associating each operation in the set of operations with the operation cookie.

5. The method of claim 4, further comprising:
establishing a set of checkpoints associated with the semantic operation; and
tracking progress of the set of checkpoints based on performing the set operations.

6. The method of claim 5 further comprising:
in response to an interruption of the set of operations, recovering operations in the set of operations based on the tracking progress of the set of checkpoints.

7. A system comprising at least one storage device and at least one hardware processor configured to:
maintain at least two data streams for each file in a file system, wherein a first data stream is associated with a cache overlay layer and a second data stream is associated with a storage layer;
maintain a logical inode tree that at least maps each file in the file system to a cache overlay layer inode and a storage layer inode, wherein the cache overlay layer inode contains metadata identifying a chunk state for each chunk of file data;
generate an operation lock on a file, wherein generating the operation lock includes generating a locking cookie and associating the locking cookie with the file;
receive an operation targeted to the file, wherein the operation is associated with an operation cookie;
in response to the operation cookie not matching the locking cookie, block the operation; and
in response to the operation cookie matching the locking cookie, perform the operation;

8. The system of claim 7, further configured to:
receive a second operation targeted to the file that is associated with a second operation cookie;
in response to the second operation cookie not matching the locking cookie, block the second operation;
in response to the second operation cookie matching the locking cookie, perform the second operation.

9. The system of claim 8, wherein performing the operation and performing the second operation in parallel.

10. The system of claim 7, further configured to:
receive a semantic operation targeted to the file;
divide the semantic operation into a set of operations; and
associate each operation in the set of operations with the operation cookie.

11. The system of claim 10, further configured to:
establish a set of checkpoints associated with the semantic operation; and
track progress of the set of checkpoints based on performing the set operations.

12. The system of claim 11, further configured to:
in response to an interruption of the set of operations, recover operations in the set of operations based on the tracking progress of the set of checkpoints.

13. A non-transitory computer readable medium with program instructions stored thereon to perform the following acts:
maintaining at least two data streams for each file in a file system, wherein a first data stream is associated with a cache overlay layer and a second data stream is associated with a storage layer;
maintaining a logical inode tree that at least maps each file in the file system to a cache overlay layer inode and a storage layer inode, wherein the cache overlay layer inode contains metadata identifying a chunk state for each chunk of file data;
generating an operation lock on a file, wherein generating the operation lock includes generating a locking cookie and associating the locking cookie with the file;
receiving an operation targeted to the file, wherein the operation is associated with an operation cookie;
in response to the operation cookie not matching the locking cookie, blocking the operation; and
in response to the operation cookie matching the locking cookie, performing the operation;

14. The non-transitory computer readable medium of claim 13, with program instructions stored thereon to further perform the following acts:
receiving a second operation targeted to the file that is associated with a second operation cookie;
in response to the second operation cookie not matching the locking cookie, blocking the second operation;
in response to the second operation cookie matching the locking cookie, performing the second operation.

15. The non-transitory computer readable medium of claim 14, wherein performing the operation and performing the second operation in parallel.

16. The non-transitory computer readable medium of claim 13, with program instructions stored thereon to further perform the following acts:
receiving a semantic operation targeted to the file;
dividing the semantic operation into a set of operations; and
associating each operation in the set of operations with the operation cookie.

17. The non-transitory computer readable medium of claim 16, with program instructions stored thereon to further perform the following acts:
establishing a set of checkpoints associated with the semantic operation; and
tracking progress of the set of checkpoints based on performing the set operations.

18. The non-transitory computer readable medium of claim 17, with program instructions stored thereon to further perform the following acts:
in response to an interruption of the set of operations, recovering operations in the set of operations based on the tracking progress of the set of checkpoints.
